(19) United States
(12) Patent Application Publication
(10) Pub. No.: US 2025/0392559 A1
(43) Pub. Date: Dec. 25, 2025

(54) METHOD, USER TERMINAL, AND SERVER FOR DISPLAYING EMOTICONS

(71) Applicant: KAKAO CORP., Jeju-si (KR)

(72) Inventor: Sang Hun LEE, Seongnam-si (KR)

(21) Appl. No.: 19/215,925

(22) Filed: May 22, 2025

(30) Foreign Application Priority Data
Jun. 24, 2024 (KR) 10-2024-0082232

(51) Int. Cl. H04L 51/10; H04L 51/04

(52) U.S. Cl. CPC H04L 51/10; H04L 51/04

(57) ABSTRACT

Proposed is a method for displaying an emoticon by a user terminal. The method may include identifying text information input into an input field of a chat room. The method may also include displaying, in response to the text information satisfying a predetermined criterion associated with keyword information corresponding to the emoticon folder, an interface for inputting at least one emoticon included in an emoticon folder in the chat room.

### CROSS-REFERENCE TO RELATED APPLICATION

This application claims priority to and the benefit of Korean Patent Application No. 10-2024-0082232 filed on Jun. 24, 2024, the disclosure of which is incorporated herein by reference in its entirety.

### BACKGROUND

### Technical Field

The present disclosure relates to a method for displaying emoticons included in an emoticon folder through a chat room by a user terminal.

### Description of Related Technology

Recent chat services allow a variety of content to be sent to chat rooms, including not only text but also emojis or emoticons. As the number of emojis or emoticons provided by chat services increases, users are having difficulty selecting appropriate emoticons during real-time chats.

Therefore, chat service operators provide user-friendly interfaces that allow users to quickly input frequently used emojis or emoticons through the Recently Used tab, the Favorites tab, and the like. In addition, the chat services provide functionality that recommends emoticons that match a specific keyword when a user inputs the specific keyword.

As such, chat service operators are providing various features to improve the convenience of using emojis or emoticons for users and to recommend emojis or emoticons customized for users.

### SUMMARY

One aspect is to create an emoticon folder for storing emoticons in a chat room, so that a user is able to save emoticons in the emoticon folder, thereby improving the convenience of the user's emoticon use.

Another aspect is to perform text matching based on text information input by a user into an input field of a chat room and keyword information corresponding to an emoticon folder, and to provide a text-matched folder.

Another aspect is a method for displaying an emoticon by a user terminal that includes identifying text information input into an input field of a chat room, and displaying, if the text information satisfies a predetermined criterion associated with keyword information corresponding to the emoticon folder, an interface for inputting at least one emoticon included in an emoticon folder in the chat room.

In one embodiment of the present disclosure, the keyword information may be determined based on information associated with at least one emoticon included in the emoticon folder.

In one embodiment of the present disclosure, the method may further include receiving at least one keyword information for the emoticon folder from a user.

In one embodiment of the present disclosure, the displaying of the interface for inputting at least one emoticon may include displaying information on the emoticon if the text information satisfies a predetermined criterion associated with the keyword information, and displaying an interface for inputting at least one emoticon included in the emoticon folder in response to an interaction with the emoticon folder.

The displaying of the information on the emoticon folder may include displaying information on at least one text-matched emoticon that satisfies matching information for the text information.

In one embodiment of the present disclosure, the displaying of the information on at least one text-matched emoticon may include displaying an interface for displaying the at least one text-matched emoticon, and the interface for displaying the at least one text-matched emoticon and the information on the emoticon folder may be displayed separately in the chat room.

The method may include obtaining an interaction for selecting an emoticon included in at least one of a chat message and an input interface, and displaying an interface for adding a selected emoticon in an emoticon folder.

In one embodiment of the present disclosure, the displaying of the interface for adding the selected emoticon to the emoticon folder may include displaying an interface for requesting creation of a new emoticon folder to add the selected emoticon, and displaying an interface for adding the selected emoticon in any one previously created emoticon folder.

In one embodiment of the present disclosure, the displaying of an interface for adding the selected emoticon to the emoticon folder may include displaying, with priority, an emoticon folder highly relevant to the selected emoticon among previously created emoticon folders.

In one embodiment of the present disclosure, the order in which at least one emoticon included in the emoticon folder is displayed may be relevant to an emoticon usage history of a user.

The method may further include requesting a server to share the emoticon folder.

At least one of (i) information about whether the shared emoticon folder is allowed to be saved and (ii) information on an emoticon available for saving from the shared emoticon folder may be determined based on a predetermined relationship between a user and another user saving the shared emoticon folder upon the request.

In one embodiment of the present disclosure, at least one of (i) information about whether the shared emoticon folder is allowed to be saved and (ii) information on any emoticon available for saving from the shared emoticon folder is determined based on emoticon usage permission for the another user.

The method may further include displaying an interface for editing the emoticon folder in response to an interaction requesting editing of the emoticon folder.

The interface for editing the emoticon folder may include at least one of the following: an interface for deleting an emoticon included in the emoticon folder, an interface for changing a display order of emoticons included in the emoticon folder, an interface for adding a new emoticon to the emoticon folder, and an interface for modifying keyword information corresponding to the emoticon folder.

Another aspect is a user terminal for displaying emoticons that includes a memory storing instructions, and a processor configured to execute the instructions to: receive text information through an input field of a chat room, and display, if the text information satisfies a predetermined criterion associated with keyword information corresponding to the emoticon folder, an interface for inputting at least one emoticon included in an emoticon folder in the chat room.

Another aspect is a method for providing emoticons by a server that includes identifying text information input into an input field of a chat room, and providing, if the text information satisfies a predetermined criterion associated with keyword information corresponding to the emoticon folder, an interface for inputting at least one emoticon included in an emoticon folder through the chat room.

The method may further include determining the keyword information based on information associated with at least one emoticon included in the emoticon folder.

Another aspect is a server providing emoticons that includes a memory storing instructions and a processor configured to execute the instructions to: identify text information input into an input field of a chat room; and providing, if the text information satisfies a predetermined criterion associated with keyword information corresponding to the emoticon folder, an interface for inputting at least one emoticon included in the emoticon folder through the chat room.

### BRIEF DESCRIPTION OF THE DRAWINGS

FIG. 1 is a diagram illustrating an example of a network environment according to one embodiment of the present disclosure.

FIG. 2 is a flowchart illustrating a method for displaying information on an emoticon included in an emoticon group by a user terminal of the present disclosure.

FIG. 3 is a flowchart illustrating a method for storing or editing an emoticon group by a user terminal of the present disclosure.

FIGS. 4 to 9 illustrate screens illustrating how a user terminal displays information on emoticons included in an emoticon folder according to one embodiment of the present disclosure.

FIG. 10 is a flowchart illustrating a method for sharing an emoticon group with another user terminal by a user terminal of the present disclosure.

FIG. 11 is an exemplary diagram illustrating a screen where another user terminal stores an emoticon folder shared by a user terminal according to one embodiment of the present disclosure.

FIG. 12 is a flowchart illustrating a method for providing information on emoticons included in an emoticon group by a server of the present disclosure.

### DETAILED DESCRIPTION

Hereinafter, embodiments of the disclosure will be described in detail with reference to the accompanying drawings, and the same or similar components are given the same reference numbers and redundant description thereof is omitted. In addition, when describing the embodiments disclosed in this specification, if it is determined that a detailed description of a related known technology may obscure the gist of the embodiments disclosed in this specification, the detailed description is omitted.

While terms including ordinal numbers, such as “first” and “second,” etc., may be used to describe various components, such components are not limited by the above terms. The above terms are used only to distinguish one component from another.

Singular expressions include plural expressions unless the context clearly indicates otherwise.

In this application, each of the steps described above may be performed irrespective of the listed order, except when performed in the listed order due to a special causal relationship.

In this application, it should be understood that terms such as “comprises” or “have” are intended to specify the presence of a feature, number, step, operation, component, part or combination thereof described in the specification, but do not exclude in advance the possibility of the presence or addition of one or more other features, numbers, steps, operations, components, parts or combinations thereof.

Hereinafter, the present disclosure will be described with reference to the attached drawings.

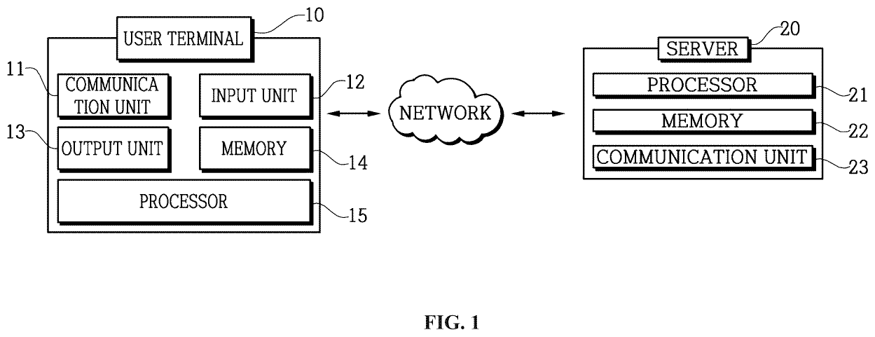

FIG. 1 is a diagram illustrating an example of a network environment according to one embodiment of the present disclosure.

A network environment according to one embodiment of the present disclosure illustrated in FIG. 1 may include a user terminal 10 and a server 20. The user terminal 10 may correspond to at least one user terminal connected to the server 20 via a network.

Communication schemes for a network are not limited. The communication schemes may include not only a communication scheme to utilize a telecommunication network (for example, a mobile communication network, wired Internet, wireless Internet, and a broadcast network), but also a short-range radio communication scheme.

The user terminal 10 may be a terminal used by a user logging in with an account registered in a chat service provided by the server 20.

The user terminal 10 may include a communication unit 11, an input unit 12, an output unit 13, a memory 14, and a processor 15.

The communication unit 11 may communicate with the server 20 or another terminal in a wired or wireless manner.

The input unit 12 may receive various information through the user's manipulation and input actions. The input unit 12 may be a touch screen module, a keyboard, a mouse, a button, a camera, a stylus, a microphone, etc.

The user terminal 10 may receive a user's interaction through the input unit 12. An interaction refers to a process where a user manipulates the input unit to input information reflecting his or her choice or intention into the user terminal 10. For example, an interaction may be touching on a touchscreen, clicking with a mouse, typing on a keyboard, providing voice input through a microphone, capturing an image using a camera, recognizing movements through a motion sensor, and the like.

The output unit 13 may output various information. The output unit 13 may be a display device, a speaker, a vibration generating device, a tactile generating device, etc. In some cases, the output unit 13 may be a device (e.g., Bluetooth earphones) that is connected to a user terminal through wired or wireless communication (e.g., short-range radio communication such as Bluetooth) to receive and output a signal.

The memory 14 functions as a storage medium and may store a number of application programs running on the user terminal 10, and data and commands for the operation of the user terminal 10. This memory 14 may be provided in the form of various storage devices such as hardware, ROM, RAM, flash drive, hard drive, etc., or in the form of web storage.

In one embodiment, the memory 14 may store an application related to a chat service capable of sending emoticons.

The processor 15 may control the overall operation of the communication unit 11, the input unit 12, the output unit 13, and the memory 14 to execute the application related to a chat service capable of sending emoticons.

In the present disclosure, the user terminal 10 may receive an interaction for selecting an emoticon included in at least one of a chat message and an input interface displayed in a chat room, and may receive an interaction for adding the selected emoticon to an emoticon group. The user terminal 10 receives text information through the chat room, and if the text information satisfies a predetermined criterion associated with keyword information corresponding to an emoticon group, the user terminal 10 may display, through the chat room, an interface for inputting at least one emoticon included in the emoticon group.

Here, an emoticon group may refer to a space where emoticons sent through a chat room can be stored. The emoticon group may be displayed in an area corresponding to an area where emoticons are displayed to be input into a chat room. For example, the emoticon group may be displayed in the form of an input interface for inputting an emoticon into an input field of a chat room. A user may create a plurality of emoticon groups. Each of the plurality of emoticon groups may include name information or keyword information to distinguish a corresponding group from other groups. For example, an emoticon group may be provided in the form of an emoticon folder. Hereinafter, it will be assumed that each emoticon group is an emoticon folder.

Here, keyword information may refer to information used for text matching with text input by the user. Text matching may be performed if text information satisfies a predetermined criterion associated with keyword information. The predetermined criterion associated with the keyword information may correspond to a case where the text information and the keyword information are related in terms of context, meaning, topic, etc.

Specifically, the text matching may be performed when text information input by the user is identical or similar to keyword information corresponding to a specific emoticon folder. Specifically, text matching may be performed when text information input by the user is identical or similar to keyword information corresponding to a specific emoticon folder. For example, when text information “Great” is input by the user, the server 20 may perform text matching on an emoticon folder associated with keyword information such as “Heart” and “Love” that are identical or semantically similar to “Great.”

When text matching is performed on a specific emoticon folder, information on a text-matched folder in which the text matching is performed may be displayed. Here, if there is a plurality of text-matched folders, the plurality of text-matched folders may be displayed as a plurality of option interfaces.

The keyword information may include a keyword and emotion information corresponding to the keyword. For example, the keyword information may include a keyword such as “Great” and information having a positive meaning corresponding to “Great.” The text information satisfying the predetermined criterion associated with the keyword information may be “Great,” which is the same text as the keyword. In addition, the text information satisfying the predetermined criterion associated with the keyword information may be “Happiness,” “Joy,” and “Pleasure,” which have the same or similar emotional information as the positive emotional information included in “Great.”

The keyword information may be the same as the name information of the emoticon folder. Specifically, when the user creates an emoticon folder, the user may only input name information of the emoticon folder. In this case, the name information and the keyword information may be identical to each other. In contrast, when the user creates an emoticon folder, the user may input keyword information separately. In this case, the name information and the keyword information may be different from each other.

When text matching is performed on a specific emoticon folder, the user terminal 10 may display a text-matched folder through the chat room. In response to an interaction with the emoticon folder from the user, the user terminal 10 may display an input interface that allows the user to input at least one emoticon included in the emoticon folder.

Here, the input interface refers to an interface for transmitting an emoticon included in the emoticon folder to the chat room. The user terminal 10 may transmit a selected emoticon to a chat room in response to a selection interaction for at least one emoticon included in the input interface.

In some cases, in response to a selection interaction for at least one emoticon included in the input interface, the user terminal 10 may display the selected emoticon in a preview form in the chat room before transmitting the selected emoticon to the chat room.

The server 20 may be implemented as a computer device or a plurality of computer devices that provide commands, codes, files, content, services, etc. The server 20 may be a server 20 capable of transmitting and receiving information through communication with the user terminal 10 via a network.

The server 20 may include a processor 21, a memory 22, and a communication unit 23.

The processor 21 controls the overall operation of the memory 22 and communication unit 23 to provide a chat service to the user terminal 10. The chat service provides a feature that allows the user terminal 10 to input an emoticon into an input field of a chat room and send the emoticon to the chat room.

The memory 22 functions as a storage medium and may store a number of application programs running on the server 20, and data and commands for the operation of the server 20. In one embodiment, the memory 22 may store an application program that provides a chat service. In addition, the memory 22 may store an emoticon that can be sent through a chat room in the chat service. Here, the emoticon may be stored in an emoticon folder.

This memory 22 may be provided in the form of any of various hardware storage devices such as an ROM, an RAM, a flash drive, a hard drive, etc. or may be provided in the form of web storage.

The communication unit 23 may communicate with the user terminal 10 via a network in a wired or wireless manner.

The server 20 of the present disclosure may provide a chat service to the user terminal 10. Specifically, the server 20 provides a chat service that allows the user terminal 10 to input an emoticon into an input field of a chat room and send the emoticon to the chat room.

In this chat service, a user may be able to participate in a plurality of chat rooms categorized by counterparts, topics, etc. Messages sent or received by the user may be displayed in a chat window of a corresponding chat room.

In the present disclosure, the server 20 may receive, from the user terminal 10, selection information for an emoticon included in at least one of a chat message and an input interface displayed in a chat room, and may add the emoticon corresponding to the selection information to an emoticon group. The server 20 may identify text information input through an input field of a chat room. If the text information satisfies a predetermined criterion associated with keyword information corresponding to an emoticon group, the server 20 may provide, through the chat room, an interface for inputting at least one emoticon included in the emoticon group.

Hereinafter, one embodiment of a method for displaying information on emoticons included in an emoticon group by a user terminal 10 of the present disclosure will be described with reference to FIGS. 2 to 9.

FIG. 2 is a flowchart illustrating a method for displaying information on at least one emoticon included in an emoticon group by the user terminal 10 of the present disclosure.

In operation 201, the user terminal 10 receives text information through a chat room.

The user terminal 10 may identify text information input by a user. The user terminal 10 may perform text matching based on the text information input by the user and keyword information corresponding to a folder (hereinafter, referred to as “keyword information”).

In addition, the user terminal 10 may perform text matching for an emoticon. When text information input by the user matches both matching information of an emoticon and keyword information corresponding to an emoticon folder, the user terminal 10 may perform keyword matching for the emoticon and the emoticon folder simultaneously.

In operation 203, if the text information satisfies a predetermined criterion associated with the keyword information corresponding to the emoticon group, an interface for inputting at least one emoticon included in the emoticon group is displayed through the chat room.

The server 20 determines whether the text information satisfies the predetermined criterion associated with the keyword information. Here, the predetermined criterion associated with the keyword information may correspond to a case where the text information and the keyword information are related in terms of context, meaning, or topic.

Specifically, keyword information may include a specific keyword and emotion information corresponding to the specific keyword. For example, keyword information may include a keyword such as “Great” and emotion information having a positive meaning corresponding to “Great.” Text information satisfying a predetermined criterion associated with the keyword information may be a specific text, “Great,” that is identical to the keyword information. In addition, the text information satisfying the predetermined criterion associated with the keyword information may be “Happiness,” “Joy,” and “Pleasure,” which have the same or similar emotional information as the positive emotional information included in “Great.”

As a result of the text matching, the user terminal 10 may display information on a text-matched folder. Here, the information on the text-matched folder may be displayed as a plurality of option interfaces.

In some cases, the user terminal 10 may perform text matching for an emoticon as well as an emoticon folder simultaneously. Specifically, an emoticon may include text information input by the user and matching information to be used for text matching. When the user terminal 10 receives text information from the user, the user terminal 10 or the server 20 determines whether the text information satisfies the matching information. For example, the matching information may be a case where text information input by the user corresponds to an emoticon keyword dictionary received by the user terminal 10 from the server 20.

If the text information satisfies the matching information, the user terminal 10 may display an interface for displaying a text-matched emoticon. The user terminal 10 may display text-matched emoticon information in response to an interaction with an interface for displaying a text-matched emoticon.

In this case, the interface for displaying a text-matched emoticon and the information on the text-matched folder may be displayed separately in the chat room.

The user terminal 10 may display an input interface for inputting at least one emoticon included in the emoticon folder. Specifically, the user terminal 10 may display at least one emoticon included in the text-matched folder in response to an interaction with the text-matched folder.

In some cases, when there is only one text-matched folder, the user terminal 10 may display an input interface for inputting at least one emoticon included in the text-matched folder in response to input of text information without an interaction with the text-matched folder.

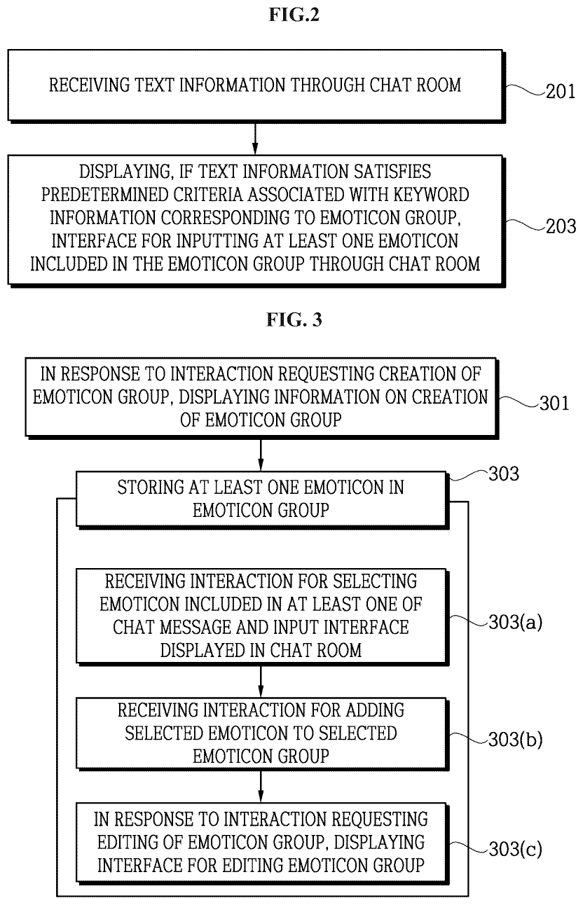

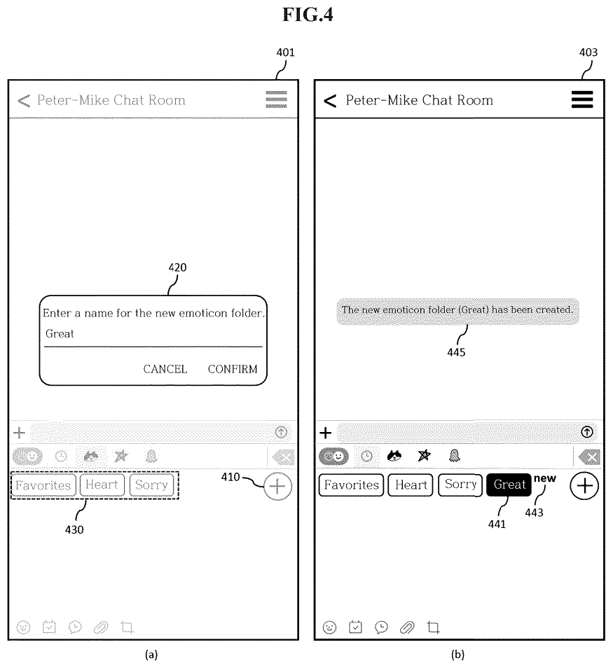

FIG. 3 is a flowchart illustrating a method for a user terminal 10 of the present disclosure to store or edit an emoticon group.

In operation 301, the user terminal 10 displays information on the creation of an emoticon group in response to an interaction requesting creation of an emoticon group.

The user terminal 10 may display a creation interface related to the creation of an emoticon folder in one area of the chat room. The creation interface may be displayed in a variety of ways.

For example, the creation interface may be displayed in an input field of a chat room. In this case, the input field may display information on the emoticon folder and a creation interface.

As another example, a creation interface may be displayed in response to interactions with a particular emoticon. Here, the specific emoticon may be any one of the emoticons that the user owns or may use. For example, the user terminal 10 may display a creation interface in response to a long tap interaction for a specific emoticon. However, the interaction that displays the creation interface here is not limited to the long tap interaction and may include other interactions.

In some cases, the creation interface may be displayed on an emoticon folder management page or an emoticon management page.

A user may create an emoticon folder through the creation interface. Specifically, the user terminal 10 may obtain an interaction from the user for the creation interface. When the user terminal 10 obtains the interaction, the user terminal 10 may display an interface that allows input of creation information for an emoticon folder.

The creation information may include at least one of name information for the emoticon folder, keyword information corresponding to the emoticon folder, and emoticon information to be stored in the emoticon folder. Here, keyword information may include a specific keyword and emotional information corresponding to the specific keyword.

For example, keyword information may include the keyword “Great.” In this case, the keyword information may include emotion information “positive” that corresponds to the keyword “Great”.

The keyword information may be determined by various methods.

For example, the keyword information may be determined based on the user's input. Specifically, when the user creates an emoticon folder, the user may input keyword information corresponding to the emoticon folder. Here, the keyword information may include a plurality of keywords.

In another example, the keyword information may be determined based on at least one emoticon included in an emoticon folder. Specifically, when the user creates an emoticon folder, if keyword information corresponding to the emoticon folder is not input, the user terminal 10 or the server 20 may determine keyword information based on emoticons included in the emoticon folder.

For example, if the emoticon folder includes only emoticons related to “Cat,” the user terminal 10 or the server 20 may determine keyword information corresponding to the emoticon folder as “Cat.”

In another example, keyword information may be determined based on matching information of emoticons included in an emoticon folder. For example, if matching information corresponding to a plurality of emoticons in an emoticon folder includes matching information “Heart,” the user terminal 10 or server 20 may determine keyword information corresponding to the emoticon folder as “Heart.”

In some cases, if the user terminal 10 or the server 20 cannot specify any one of the keyword information corresponding to a plurality of emoticons in an emoticon folder, the keyword information corresponding to the emoticon folder may not be determined.

In some cases, the user terminal 10 or the server 20 may determine keyword information corresponding to an emoticon folder based on an initially stored emoticon. For example, when a first saved emoticon includes matching information “Great” and a subsequently saved emoticon includes matching information “Heart”, the user terminal 10 or the server 20 may determine keyword information corresponding to the emoticon folder as “Great”.

In operation 303, the user terminal 10 or the server 20 stores at least one emoticon in the emoticon group. In FIG. 3, operation 303 is exemplarily illustrated as being performed after operation 301, but aspects of the present disclosure are not limited thereto.

In operation 303(a), the user terminal 10 obtains an interaction for selecting an emoticon included in a chat message and an input interface displayed in a chat room.

The user terminal 10 or the server 20 may store a first emoticon in the emoticon folder. Specifically, the user terminal 10 may display at least one emoticon to be stored in the emoticon folder. Here, at least one emoticon may be included in the chat message or the input interface for entering emoticons.

The user terminal 10 or the server 20 may obtain a selection interaction for the first emoticon to be stored in the emoticon folder among at least one emoticon. The user terminal 10 or the server 20 may store the first emoticon in the emoticon folder in response to the selection interaction.

In operation 303(b), the user terminal 10 displays an interface for adding a selected emoticon to the emoticon folder.

When the user terminal 10 obtains the selection interaction for the first emoticon, the user terminal 10 may display an interface for adding the selected emoticon to the emoticon folder. The interface for adding a selected emoticon to the emoticon folder may be displayed in various ways, depending on how the first emoticon is to be stored.

For example, the interface for adding the selected emoticon to the emoticon folder may present an option interface for selecting any one created emoticon folder. Specifically, when the user selects the first emoticon, the user terminal 10 may display an option interface including name information of a previously created emoticon folder. The user terminal 10 may store the first emoticon in a selected folder in response to a selection interaction for any one option interface.

In another example, the interface for adding the selected emoticon in the emoticon folder may present an input interface. Specifically, when the user selects the first emoticon, the user terminal 10 may display the input interface, which is used to input an emoticon included in the emoticon folder, in order to add the first emoticon to the emoticon folder. The user terminal 10 may save the first emoticon in the emoticon folder in response to input of dragging the first emoticon into the input interface.

In another example, the interface for adding the selected emoticon in the emoticon folder may present a save interface. Specifically, the user terminal 10 may display the save interface that allows the user to save the first emoticon in the emoticon folder by a long tap interaction (or a right click interaction) with the first emoticon from the user. The user terminal 10 may store the first emoticon in the emoticon folder in response to an interaction with the save interface.

The interface for adding the selected emoticon in the emoticon folder may be displayed along with an interface for requesting creation of a new emoticon folder to add the selected emoticon. In this case, the user may include the first emoticon in any one previously created emoticon folder, or, when no previously created emoticon folder is suitable to store the first emoticon, the user may create a new emoticon folder using the interface for requesting creation of a new emoticon folder, and then store the first emoticon in the new emoticon folder.

When the user terminal 10 obtains a selection interaction for the first emoticon, the user terminal 10 may display, with priority, an emoticon folder that is highly relevant to the first emoticon among previously created emoticon folders. Here, the relevant emoticon folder may be related to the category or matching information of the first emoticon.

For example, if the first emoticon is an emoticon related to “Cat,” the emoticon folder “Cat” may be displayed with priority over other previously created emoticon folders. In addition, if matching information corresponding to the first emoticon is “Great,” the emoticon folder “Great” may be displayed with priority over other previously created emoticon folders.

The display order of emoticons in an emoticon folder may be determined based on the user's emoticon usage history. For example, the display order of emoticons may be determined based on which emoticons have been recently used by the user. In addition, the display order of emoticons may be determined by the number of times the user has sent each individual emoticon.

In operation 303(c), the user terminal 10 displays an interface for editing the emoticon group in response to an interaction requesting editing of the emoticon group.

The user terminal 10 may display the interface for editing the emoticon folder. Specifically, the user terminal 10 may display the interface for editing an emoticon folder in response to an interaction requesting editing of emoticon folder from the user.

The interface for editing the emoticon folder may include at least one of the following: an interface for deleting an emoticon included in the emoticon folder, an interface for changing the display order of emoticons included in the emoticon folder, an interface for adding a new emoticon to the emoticon folder, and an interface for modifying keyword information corresponding to the emoticon folder.

The user may delete an emoticon included in the emoticon folder, using the interface for deleting an emoticon. In some cases, the user may delete the emoticon folder itself. In this case, the emoticon folder and all emoticons included in the emoticon folder may be deleted.

The interface for changing the display order of emoticons may be an input interface that displays a specific emoticon folder and the emoticons included in the specific emoticon folder. In this case, by dragging any one emoticon included in the emoticon folder, the user may change the display order of emoticons in the emoticon folder.

The user terminal 10 may additionally store a new emoticon in the emoticon folder in response to a request from the user to add the new emoticon to the emoticon folder, according to the method described above.

When the user terminal 10 obtains an interaction from the user with the interface for editing the emoticon folder, the user terminal 10 may display the interface for modifying keyword information corresponding to the emoticon folder. The user may modify keyword information corresponding to the emoticon folder, using the interface for modifying keyword information.

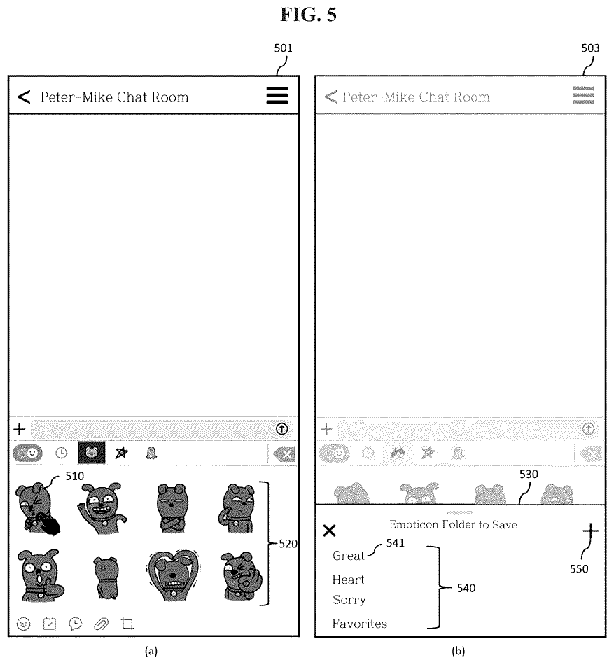

Hereinafter, an example of a method for displaying an emoticon included in an emoticon group by the user terminal 10 according to one embodiment of the present disclosure will be described with reference to FIGS. 4 to 9.

FIG. 4 illustrates a screen where the user terminal 10 according to one embodiment of the present disclosure obtains a request to create an emoticon folder 441 from a user.

In FIG. 4, (a) shows a screen displaying an interface 420 through which the user terminal 10 is able to input creation information for an emoticon folder in a chat room 401.

In FIG. 4, (b) shows a screen where the user terminal 10 displays information 430 regarding emoticon folder creation in a chat room 403.

Referring to (a) of FIG. 4, in response to an interaction with a creation interface 410 related to emoticon folder creation, the user terminal 10 may display the interface 420 for inputting creation information on an emoticon folder.

The creation interface 410 may be displayed in various ways.

For example, the creation interface 410 may be displayed in an input field of the chat room. In this case, the input field may display information on the emoticon folder 430 and the creation interface 410. A user may create an appropriate new emoticon folder without creating a duplicate emoticon folder by considering the information on the emoticon folder displayed in the input field.

In response to the interaction with the creation interface 410, the user terminal 10 may display the interface 420 for inputting creation information. The user may input name information and keyword information for the new emoticon folder through the interface 420 for inputting creation information.

Although not shown in the drawings, the interface 420 for inputting creation information may include an interface for inputting keyword information for an emoticon folder. In this case, the user may input the name information and keyword information for the emoticon folder separately. Accordingly, the name information and the keyword information may be different from each other.

Referring to (b) of FIG. 4, the user terminal 10 may create the emoticon folder “Great” 441 in response to a request for creation of the emoticon folder “Great” 441 from the user. The user terminal 10 may display information 441, 443, and 445 regarding emoticon folder creation in response to the creation of the emoticon folder “Great” 441.

Here, the information 441, 443, and 445 regarding emoticon folder creation may include information on the emoticon folder 441, new emoticon folder creation information 443, and creation-related notification information 445. For example, the information regarding emoticon folder creation may be that the emoticon folder “Great” 441 is newly created in (b) of FIG. 4. In addition, along with the creation of the emoticon folder “Great” 441, new emoticon folder creation information “new” 443 and notification information “A new emoticon folder (Great) has been created” 445 may be included.

FIG. 5 illustrates a screen where the user terminal 10 according to one embodiment of the present disclosure saves a first emoticon 510, which is selected from among emoticons displayed on an input interface 520, in an emoticon folder 531.

In FIG. 5, (a) shows a screen where the user terminal 10 obtains an interaction for selecting an emoticon included in the input interface 520 through a chat room 501.

In FIG. 5, (b) shows a screen where the user terminal 10 displays, through a chat room 503, an interface 530 for adding a selected emoticon to an emoticon folder.

Referring to (a) of FIG. 5, the user terminal 10 may save the first emoticon 510 in an emoticon folder. Specifically, when the user terminal 10 obtains a selection interaction for the first emoticon included in the input interface 520, the user terminal 10 may display an interface for adding the first emoticon to the emoticon folder.

Referring to (b) of FIG. 5, the user terminal 10 may display an interface 530 for adding the first emoticon to the emoticon folder. Here, the interface 530 for adding the first emoticon in the emoticon folder may include an interface 540 for adding the first emoticon to any one previously created emoticon folder and an interface 550 for requesting creation of a new emoticon folder to which the first emoticon is to be added.

When the user terminal 10 obtains a selection interaction for the first emoticon, the user terminal 10 may display, with priority, an emoticon folder that is highly relevant to the first emoticon among previously created emoticon folders. Here, an emoticon folder highly relevant to the first emoticon may be determined based on matching information corresponding to the first emoticon. For example, in a case where the matching information corresponding to the first emoticon is “Great,” if the user terminal 10 obtains a selection interaction for the first emoticon 510 in (a) of FIG. 5, the user terminal 10 may display the emoticon folder “Great” 541 with priority over other previously created emoticon folders.

In some cases, when there is no emoticon folder highly relevant to the first emoticon, the user terminal 10 may display a previously created emoticon folder according to a predetermined method. Here, the predetermined method may be relevant to at least one of (i) the order in which emoticon folders are created and (ii) the emoticon folder in which the most recently saved emoticon is stored.

When the user terminal 10 obtains a selection interaction for a specific folder 541 among the previously created emoticon folders, the first emoticon may be stored in the specific folder 541. In contrast, when the user terminal 10 obtains an interaction with the interface 550 for requesting creation of a new emoticon folder, the user terminal 10 may create the new emoticon folder and save the first emoticon in the new emoticon folder.

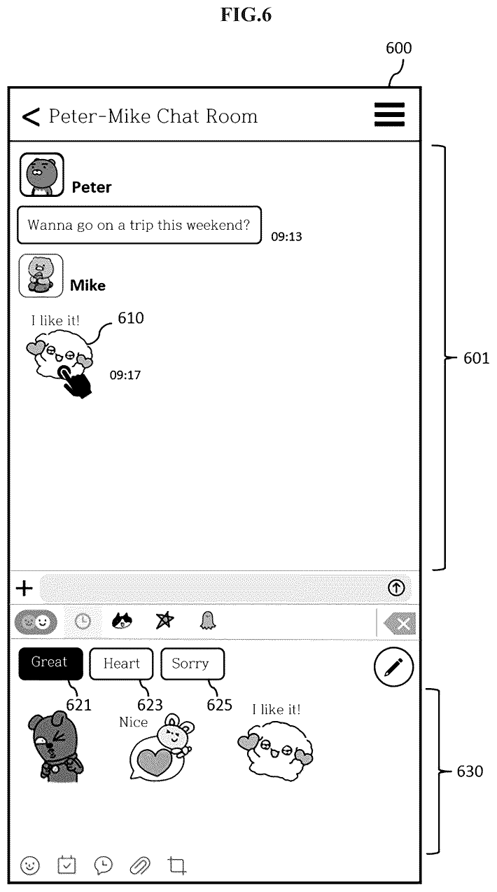

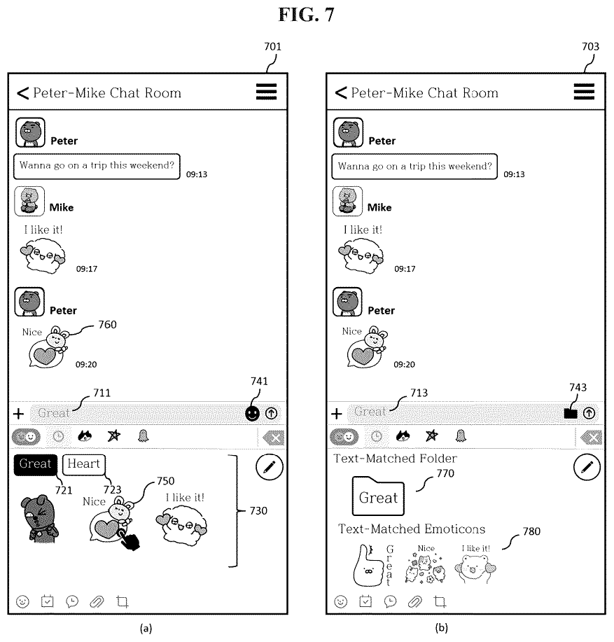

FIG. 6 illustrates a screen where the user terminal 10 according to one embodiment of the present disclosure saves a second emoticon 610, which is selected from among emoticons displayed in a chat window 601 of a chat room 600, in a specific emoticon folder 621.

Referring to FIG. 6, the user terminal 10 may display a chat message in the chat window 601. Here, the chat message may include at least one emoticon 610. When the user terminal 10 obtains an interaction with the second emoticon 610 included in the chat message, the user terminal 10 may display an interface for adding the second emoticon 610 to an emoticon folder. Here, the interface for adding to an emoticon folder may correspond to an input interface 630 of a specific emoticon folder.

Specifically, when the user selects the second emoticon 610, the user terminal 10 may display the input interface 630 to add the second emoticon 610 to the emoticon folder. The user terminal 10 may store the second emoticon 610 in a specific emoticon folder 621 in response to input of dragging the second emoticon 610 into the input interface 630.

In some cases, although not shown in the drawings, when the user terminal 10 obtains a long tap interaction with the second emoticon 610 from the user, the user terminal 10 may display the interface 530 for adding an emoticon to an emoticon folder, as shown in (b) of FIG. 5.

In contrast to what is shown in the drawing, the second emoticon may be an emoticon sent by the user terminal (Peter's terminal) 10 to the chat window 601.

The user terminal 10 may display, with priority, an emoticon folder that is highly relevant to the selected emoticon among previously created emoticon folders 621, 623, and 625. Here, the emoticon folder highly relevant to the selected emoticon may be determined based on matching information corresponding to the selected emoticon.

For example, in a case where the matching information corresponding to the first emoticon is “Great,” if the user terminal 10 obtains an interaction with the second emoticon 610, the emoticon folders “Great” 621 and “Heart” 623 identical or similar to the matching information of the second emoticon 610 may be displayed with priority over the emoticon folder “Sorry” 625. In some cases, only the emoticon folders 621 and 623 highly relevant to the selected emoticon may be displayed.

The display order of emoticons included in the emoticon folder 621 may be based on the user's emoticon usage history. For example, if Peter has no history of sending the second emoticon 610 to the chatroom, the second emoticon 610 may be displayed after the other emoticons.

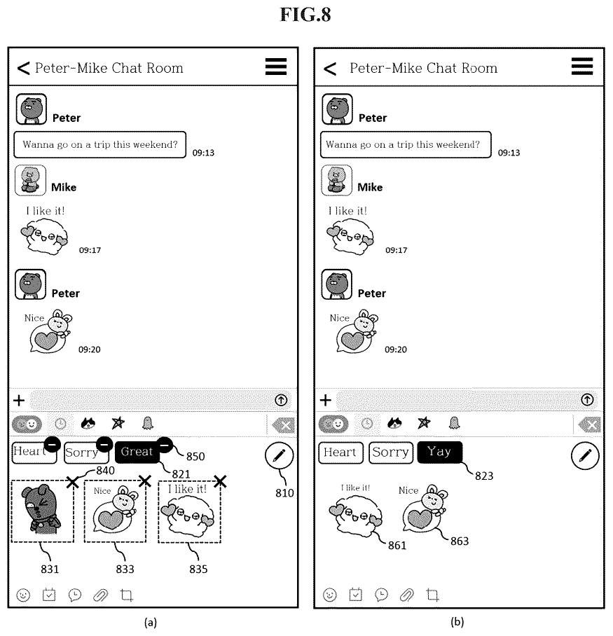

FIG. 7 illustrates a screen where the user terminal 10 according to one embodiment of the present disclosure performs text matching 711 and 713 and displays text-matched folders 721 and 723.

Referring to (a) and (b) of FIG. 7, unlike FIG. 6, only the emoticon folders “Great” 721 and “Heart” 723 may be displayed. This may be the result of text matching based on text information 711 input by the user and keyword information corresponding to an emoticon folder.

The user terminal 10 may receive text information “Great” 711 from the user in an input field of a chat room 701. The user terminal 10 may perform text matching based on the text information 711 input by the user and keyword information corresponding to the emoticon folder.

Specifically, the user terminal 10 or server 20 determines whether the text information 711 satisfies a criterion associated with keyword information 721 and 723. If the text information 711 satisfies the criterion associated with the keyword information 721 and 723, the user terminal 10 may display an interface 730 for inputting at least one emoticon included in an emoticon folder into a chat room 701. Here, the predetermined criterion associated with the keyword information may correspond to a case where the text information and the keyword information are related in terms of context, meaning, or topic.

For example, in a case where text information “Great” 711 is input by the user, if keyword information corresponding to an emoticon folder is “Great” 721 which is identical to the text information “Great” 711, or if the keyword information corresponding to the emoticon folder is “Heart” 723 which is similar to “Great,” the interface 730 for inputting at least one emoticon included in the emoticon folder may be displayed. Here, “Great” 721 and “Heart” 723 may be classified as similar keywords because both “Great” and “Heart” imply the same “positive emotion.”

The user terminal 10 may simultaneously perform text matching for an emoticon as well as the emoticon folders 721 and 723. Specifically, the emoticon may include the text information 711 input by the user and matching information (e.g., “Great”) for text matching. When the user terminal 10 receives text information (e.g., “Great” 711) from the user, the user terminal 10 or the server 20 determines whether the text information 711 satisfies the matching information.

As shown in (a) of FIG. 7, if the text information 711 satisfies the matching information, the user terminal 10 may display an interface 741 for displaying a text-matched emoticon. In such a case, the interface 741 for displaying text-matched emoticons and information on text-matched folder 721 and 723 may be displayed separately in the chat room.

Although not shown in the drawings, when the user terminal 10 obtains an interaction from the user with the interface 741 for displaying emoticons, the user terminal 10 may display information on text-matched emoticons for which text matching has been performed with “Great.” Here, the display order of text-matched emoticons may be determined based on whether each of the emoticons is stored in an emoticon folder. For example, among the text-matched emoticons, emoticons stored in any emoticon folders may be displayed with priority over other emoticons not stored in any emoticon folders.

In some cases, when an interaction with the interface 741 is obtained, information 721, 723, and 730 on the text-matched folders may no longer be displayed in an input interface area, and only information on the text-matched emoticons may be displayed. Accordingly, when the interaction with the interface 741 is obtained in (a) of FIG. 7, the information 721, 723, and 730 on the text-matched folders shown in (a) of FIG. 7 may be replaced with information 780 on text-matched emoticons shown in (b) of FIG. 7.

In addition, when the information 780 on text-matched emoticons is displayed in the input interface area, the interface 741 may be replaced with an interface that displays information 743 on a text-matched folder 743.

When the user terminal 10 obtains an interaction with one emoticon 750 among emoticons stored in an emoticon folder, the user terminal 10 may transmit a selected emoticon 750 to the chat room 701. Although not shown in the drawings, when the user terminal 10 obtains an interaction with one emoticon 750 among the emoticons stored in the emoticon folder, the user terminal 10 may display the selected emoticon 750 in an emoticon preview input field of the chat room 701. Then, upon a request to transmit the selected emoticon 750 to the chat room, the user terminal 10 may display the selected emoticon 750 in the chat room 701.

In addition, as shown in (b) of FIG. 7, if text information 713 satisfies the matching information, the user terminal 10 may display information 770 on a text-matched folder and information 780 on text-matched emoticons together. The user terminal 10 may display the information 770 on the text-matched folder and the information 780 on text-matched emoticons separately in an input interface area of a chat room 703. Accordingly, the user may select any one of a text-matched folder and a text-matched emoticon and input the selected one into the input interface.

FIG. 8 illustrates a screen on which a user edits an emoticon folder according to one embodiment of the present disclosure.

In FIG. 8, (a) shows a screen displaying interfaces 831, 833, 835, and 840 that allows the user terminal 10 to edit an emoticon folder.

In FIG. 8, (b) shows a screen that is displayed after the user terminal 10 edits an emoticon folder.

Referring to (a) of FIG. 8, the user may edit an emoticon folder. Specifically, in response to an interaction requesting editing 810 of an emoticon folder, the user terminal 10 may display the interfaces 831, 833, 835, and 840 for editing an emoticon folder. Here, the interface for editing an emoticon folder may include an interface 840 for deleting an emoticon included in the emoticon folder, and the interfaces 831, 833, and 835 for changing the display order of emoticons included in the emoticon folder.

Although not shown in the drawings, the interface for editing an emoticon folder may include an interface for adding a new emoticon to the emoticon folder and an interface for modifying keyword information corresponding to the emoticon folder.

The user may delete any one emoticon 831 among the emoticons in the emoticon folder, through the interface 840 for deleting the emoticon. In some cases, the user may delete the emoticon folder itself. Specifically, the user may delete a specific emoticon folder 821 through an interface 850 that allows the user to delete the emoticon folder.

The user may change the display order of emoticons. Specifically, the user terminal 10 may display emoticons 831, 833, and 835 stored in the emoticon folder. By dragging any one emoticon, the user may change the display order of emoticons in the emoticon folder.

Referring to (b) of FIG. 8, it may be confirmed that one emoticon 831 among the emoticons shown in (a) of FIG. 8 is deleted. This may be a result of the user terminal 10 obtaining an interaction with the interface 840 that allows the user to delete one of the emoticons.

Also, referring to (b) of FIG. 8, unlike the emoticons 833 and 835 shown in (a) of FIG. 8, the display order of emoticons 861 and 863 shown in (b) of FIG. 8 has been changed. This may be a result of the user terminal 10 reordering the emoticons based on the user's interaction for changing the display order of emoticons.

In addition, referring to (b) of FIG. 8, keyword information shown in (b) of FIG. 8 is “Yay” 821, unlike the keyword information shown in (a) of FIG. 8, which is “Great” 823. This may be a result of the user terminal 10 modifying keyword information on the emoticon folder “Great” 821 to “Yah” 823, in response to the user's operation.

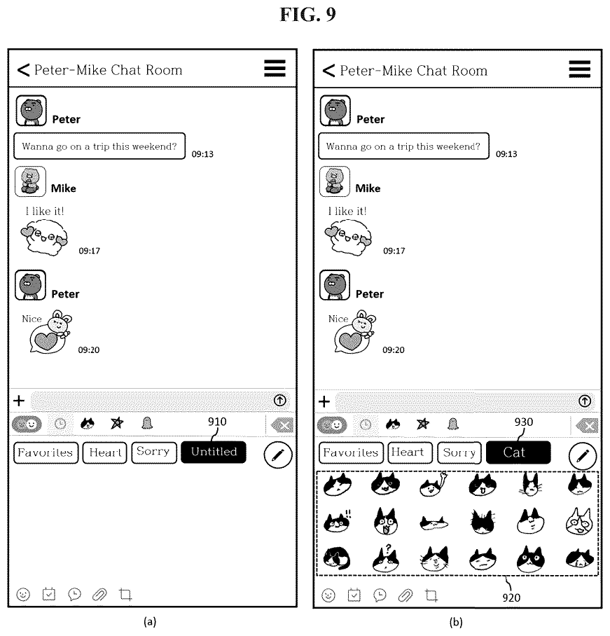

FIG. 9 illustrates a screen where the user terminal 10 or the server 20 determines keyword information based on emoticons 920 included in an emoticon folder according to one embodiment of the present disclosure.

Referring to (a) of FIG. 9, when creating an emoticon folder, the user may not input name information or keyword information for an emoticon folder. In this case, the name information (or keyword information) for the emoticon folder may be determined as “Untitled” 910 or “None.”

Referring to (b) of FIG. 9, the user terminal 10 or the server 20 may determine the keyword information based on the emoticons 920 included in the emoticon folder. For example, when the server 20 receives a request from the user terminal 10 to save a cat-related emoticon in an emoticon folder, the server 20 may determine keyword information corresponding to the emoticon folder as “Cat.” In addition, in some cases, the user terminal 10 may check information 920 about the emoticons stored in the emoticon folder and determine keyword information corresponding to the emoticon folder as “Cat.”

In this case, the keyword information (or name information) included in option interfaces 910 and 930 may be modified from “Untitled” 910 shown in (a) of FIG. 9 to “Cat” 930 shown in (b) of FIG. 9.

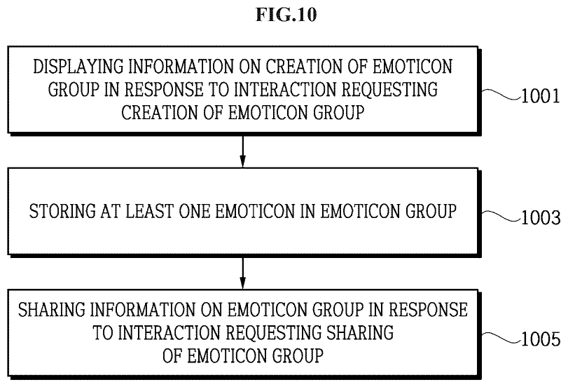

FIG. 10 is a flowchart illustrating a method for sharing an emoticon group with another user terminal by a user terminal 10 of the present disclosure.

For convenience of explanation, the description of operations in FIG. 10 that are substantially the same as operations in FIG. 3 will be replaced with a description referring to FIG. 3.

Operations 1001 and 1003 are substantially the same as operations 201 and 203 of FIG. 2, so the description of FIG. 2 is replaced.

In operation 1005, the user terminal 10 shares information on an emoticon group in response to an interaction requesting sharing of the emoticon group.

The user terminal 10 may share the emoticon folder. Specifically, the user terminal 10 may share information on an emoticon folder in response to an interaction requesting sharing of an emoticon folder from a user.

The information on the emoticon folder may be shared in various ways.

For example, the information on the emoticon folder may be shared through a chat room. Specifically, the user terminal 10 may share the information on the emoticon folder through a 1:1 chat room with another user or a group chat room in which a plurality of other users participate.

In another example, the information on the emoticon folder may be shared on a separate page where emoticon folders (or emoticons) are shared or sold. Specifically, the user terminal 10 may share his or her emoticon folder for free on a sharing page or by selling the emoticon folder on an emoticon folder sales page (or emoticon sales page).

Details of the shared emoticon folder may be determined based on a relationship between the user and another user who wishes to save the shared emoticon folder. Specifically, at least one of (i) information about whether the shared emoticon folder is allowed to be saved and (ii) information on any emoticon available for sharing from the shared emoticon folder may be determined based on a relationship between the user and the another user.

For example, the shared emoticon folder may be saved only when the user has a special relationship with the another user, such as a friend connection. In addition, when the another user has a friend connection with the user, the emoticon folder may be shared in a manner in which all emoticons included in the emoticon folder can be saved. However, when the another user does not have a friend connection with the user, the emoticon folder may be shared in a manner in which only some emoticons allowed by the user can be saved.

A terminal of another user attempting to save a shared emoticon folder may determine at least one of (i) information about whether the shared emoticon folder is allowed to be saved and (ii) information on any emoticon available for saving from the shared emoticon folder, based on at least one of emoticon usage permission, emoticon usage history, emoticon purchase history, emoticon favorite history, and emoticon download history of the another user. For example, when an emoticon folder includes an emoticon that the another user does not have permission to use, only emoticons for which the another user has permission to use may be saved.

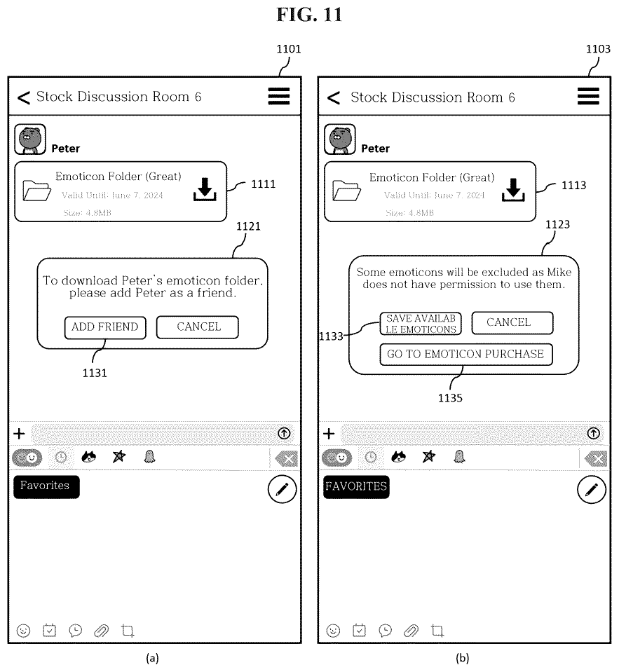

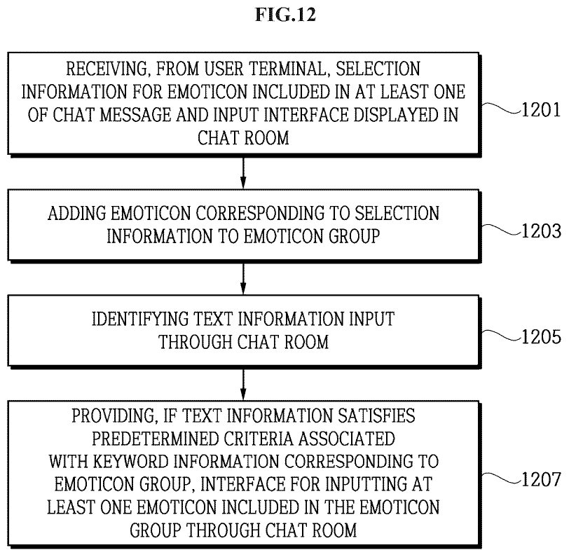

FIG. 11 is an exemplary illustration of a screen where another user terminal stores emoticon folders 1111 and 1113 shared by the user terminal 10 according to one embodiment of the present disclosure.

In FIG. 11, the user who shares an emoticon folder is called Peter, and the another user who attempts to save the emoticon folder is called Mike.

In FIG. 11, (a) shows an example screen illustrating how to determine whether the shared emoticon folder 1111 is allowed to be saved, depending on whether Peter and Mike has a friend connection.

In FIG. 11, (b) shows an example screen illustrating how to determine whether the shared emoticon folder 1113 is allowed to be saved, based on whether Mike has permission to use each individual emoticon.

Referring to (a) of FIG. 11, the user terminal 10 may share the emoticon folder 1111. Specifically, the user terminal 10 may share the emoticon folder 111 through a chat room 1101. For example, the chat room 1101 may be a group chat room in which a plurality of other users participate.

When a specific user among the other users participating in the chat room 1101 attempts to save the shared emoticon folder 1111, whether the shared emoticon folder 1111 is allowed to be saved may be determined based on a relationship between a specific user and the user of the user terminal 10. For example, suppose that Peter and Mike does not have a friend connection. In this case, when the server 20 receives a request to save the shared emoticon folder 1111 from Mike's terminal, the server 20 may provide the pop-up message “To download Peter's emoticon folder, please add Peter as a friend” 1121 to Mike's terminal. Here, the pop-up message may include an interface 1131 that allows the user to add Peter as a friend.

Mike's terminal may add Peter as a friend by interacting with the interface 1131 for adding a friend or by any other method provided by a chat service to add a friend. Thereafter, Mike's terminal may save the emoticon folder 1111 shared by Peter's terminal.

Referring to (b) of FIG. 11, another user participating in a chat room 1103 may determine whether the shared emoticon folder 1113 is allowed to be saved, based on whether the another user has permission to use each individual emoticon. For example, when Mike's terminal does not have permission to use a first emoticon included in the shared emoticon folder 1113 and the server 20 receives a request from Mike's terminal to save the shared emoticon folder 1113, the server 20 may provide the pop-up message “Some emoticons will be excluded as Mike does not have permission to use them” 1023. Here, the pop-up message may include an interface 1133 for saving an emoticon folder, excluding the first emoticon, and an interface 1135 for moving to a page for purchasing the first emoticon.

Through the interface 1133 for saving the emoticon folder 1113 excluding the first emoticon, Mike's terminal may save the emoticon folder 1113, without purchasing the first emoticon.

In addition, Mike's terminal may purchase the first emoticon through the interface 1135 for moving to a page for purchasing the first emoticon or through a method such as purchasing another emoticon provided by the chat service, and then save the shared emoticon folder 1113.

FIG. 12 is a flowchart illustrating a method for providing emoticons included in an emoticon group by a server 20 of the present disclosure.

For convenience of explanation, descriptions of operations in FIG. 12 that are substantially the same as operations in FIG. 2 or FIG. 3 are replaced with descriptions referring to FIG. 2 or FIG. 3.

In operation 1201, the server 20 receives, from a user terminal 10, selection information for an emoticon included in at least one of a chat message and an input interface displayed in a chat room. Since operation 1201 is substantially the same as operation 303(a) of FIG. 3, the description of operation 1201 is replaced with the description of operation 303(a) of FIG. 3.

In operation 1203, the server 20 includes the emoticon corresponding to the selection information in the emoticon group. Since operation 1203 is substantially the same as operation 303(b) of FIG. 3, the description of operation 1203 is replaced with the description of operation 303(b) of FIG. 3.

In operation 1205, the server 20 verifies text information input through the chat room. Since operation 1205 is substantially the same as operation 201 of FIG. 2, the description of operation 1205 is replaced with the description of operation 201 of FIG. 2.

In operation 1207, if the text information satisfies a predetermined criterion associated with the keyword information corresponding to the emoticon group, the server 20 provides an interface for inputting at least one emoticon included in the emoticon group through the chat room. Since operation 1207 is substantially the same as operation 203 of FIG. 2, the description of operation 1207 is replaced with the description of operation 203 of FIG. 2.

According to the present disclosure, an emoticon folder for storing emoticons may be created in a chat room, so that a user is able to save emoticons in the emoticon folder, thereby improving the convenience of the user's emoticon use.

According to the present disclosure, text matching may be performed based on text information input by the user into an input field of a chat room and keyword information corresponding to an emoticon folder, and a text-matched folder may be provided.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiment and the accompanying drawings, and various modifications and changes may be made in view of the person skilled in the art to which the present disclosure pertains. Therefore, the scope of the present disclosure should be determined by the scope of the appended claims, and equivalents thereof.

What is claimed is:

1. A method for displaying emoticons by a user terminal, the method comprising:
receiving an interaction for selecting an emoticon included in at least one of a chat message or an input interface displayed in a chat room;
receiving an interaction for adding the selected emoticon to an emoticon group;
receiving text information through the chat room; and
displaying, in response to the text information satisfying a predetermined criterion associated with keyword information corresponding to the emoticon group, an interface for inputting at least one emoticon included in the emoticon group through the chat room.

2. The method of claim 1, wherein the keyword information is determined based on information associated with at least one emoticon included in the emoticon group.

3. The method of claim 1, further comprising receiving at least one keyword information for the emoticon group from a user.

4. The method of claim 1, wherein displaying the interface for inputting the at least one emoticon comprises:
displaying information on the emoticon group in response to the text information satisfying the predetermined criterion associated with the keyword information; and
in response to an interaction with the emoticon group, displaying an interface for inputting at least one emoticon included in the emoticon group.

5. The method of claim 4, wherein displaying the information on the emoticon group comprises displaying information on at least one text-matched emoticon that satisfies matching information for the text information.

6. The method of claim 5, wherein:
displaying the information on the at least one text-matched emoticon comprises displaying an interface for displaying the text-matched emoticon, and
an interface for displaying the at least one text-matched emoticon and information on the emoticon group are displayed separately in the chat room.

7. The method of claim 1, wherein receiving the interaction for adding the selected emoticon to the emoticon group comprises:
displaying an interface for requesting creation of a new emoticon group including the selected emoticon; and
receiving an interaction for adding the selected emoticon to the new emoticon group generated according to the interface for requesting the creation of the new emoticon group.

8. The method of claim 7, wherein the interface for requesting the creation of the new emoticon group comprises an interface for inputting keyword information corresponding to the new emoticon group.

9. The method of claim 1, wherein receiving the interaction for adding the selected emoticon to the emoticon group comprises receiving an interaction for adding the selected emoticon to any one previously created emoticon group.

10. The method of claim 9, wherein receiving the interaction for adding the selected emoticon to the emoticon group comprises displaying, with priority, an emoticon group that is highly relevant to the selected emoticon among previously created emoticon groups.

11. The method of claim 1, wherein an order in which at least one emoticon included in the emoticon group is displayed is related to an emoticon usage history of a user.

12. The method of claim 1, further comprising requesting a server to share the emoticon group.

13. The method of 12, wherein, at least one of (i) information about whether another user account is allowed to save the shared emoticon group or (ii) any emoticon available for saving from the shared emoticon group is determined based on a predetermined relationship between a user account requesting the sharing and the another user account.

14. The method of 12, wherein at least one of (i) information about whether another user account is allowed to save the shared emoticon group or (ii) information on any emoticon available for saving from the shared emoticon group is determined based on emoticon usage permission for the another user account.

15. The method of claim 1, further comprising, in response to an interaction requesting editing of the emoticon group, displaying an interface for editing the emoticon group.

16. The method of claim 15, wherein the interface for editing the emoticon group comprises at least one of the following: an interface for deleting an emoticon included in the emoticon group, an interface for changing a display order of emoticons included in the emoticon group, an interface for adding a new emoticon to the emoticon group, or an interface for modifying keyword information corresponding to the emoticon group.

17. A method for providing emoticons by a server, comprising:
receiving, from a user terminal, selection information for an emoticon included in at least one of a chat message or an input interface displayed in a chat room;
adding the emoticon corresponding to the selection information to an emoticon group;
identifying text information input through an input field of the chat room; and
providing, in response to the text information satisfying a predetermined criterion associated with the keyword information corresponding to the emoticon group, an interface for inputting at least one emoticon included in the emoticon group through the chat room.

18. The method of claim 17, further comprising determining the keyword information based on information associated with at least one emoticon included in the emoticon group.

19. A server providing emoticons, comprising:
a memory storing instructions, and
a processor configured to execute the instructions to:
receive, from a user terminal, selection information for an emoticon included in at least one of a chat message or an input interface displayed in a chat room;
add the emoticon corresponding to the selection information to an emoticon group;
identify text information input through the chat room; and
provide, in response to the text information satisfying a predetermined criterion associated with keyword information corresponding to the emoticon group, an interface for inputting at least one emoticon included in the emoticon group through the chat room.
